(19) United States
(12) Patent Application Publication
(10) Pub. No.: US 2009/0145309 A1
(43) Pub. Date: Jun. 11, 2009

(54) COMPACTOR WITH PIVOTING COMPACTION PLATE

(76) Inventor: Anthony Fox, Bloomington, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/950,979

(22) Filed: Dec. 5, 2007

(51) Int. Cl. B30B 15/18; B30B 9/00

(52) U.S. Cl. 100/35; 100/229 R; 100/233; 100/345; 100/48

(57) ABSTRACT

In some embodiments, a compactor may include one or more of the following features: (a) a frame coupled to a base having side panels with a front portion, a side wall, and a rear portion, (b) a compaction plate assembly including a platen pivotally coupled to the side walls for rotation about a fixed axis, (c) a compaction plate driver coupled to a rear wall for driving the platen in a semicircular direction toward and away from a rear wall of a cart, (d) an electrical switch for preventing operation of the compaction plate driver when a door member coupled to the frame is ajar, and (e) a speaker for playing an audio message upon actuation of an electric motor.

### FIELD OF THE INVENTION

Embodiments of the present invention relate generally to waste management. Particularly, embodiments of the present invention relate to improved methods and apparatus for handling waste products. More particularly, embodiments of the present invention relate to trash compactors.

### BACKGROUND

Many fast food restaurants and cafeterias typically provide a refuse or waste container near the establishment exit and at other convenient locations where, at the conclusion of a meal, the patron's tray containing napkins, paper cups, food wrappers, placemats, etc. can be dumped into the waste receptacle by the patron rather than by restaurant staff. However, it is up to the restaurant staff to periodically empty these trash receptacles by bagging the waste materials and then depositing the bagged waste in a dumpster for pick-up by a refuse removal service.

Since the waste material falls by gravity in the conventional waste receptacles currently used, the waste material is not packed particularly dense and frequent emptying of the waste receptacles by staff personnel is required to prevent overflow. The need to frequently empty the refuse receptacles can be a significant cost item for restaurant operation. Moreover, since refuse haulers generally charge by volume and not by weight, loosely-compacted bagged refuse takes up an inordinate amount of space in a dumpster adding to the cost of refuse disposal.

A compactor is a machine or mechanism used to reduce the size of waste material through compaction. Normally powered by hydraulics, compactors take many shapes and sizes. In landfill sites for example, a large bulldozer with spiked wheels is used to drive over waste deposited by waste collection vehicles (WCVs). WCVs themselves incorporate a compacting mechanism which is used to increase the payload of the vehicle and reduce the number of times it has to empty. This usually takes the form of hydraulically-powered sliding plates which sweep out the collection hopper and compress the material into what has already been loaded.

Different compactors are used in scrap metal processing, the most familiar being the car crusher. Such devices can either be of the “pancake” type, where a scrap automobile is flattened by a huge descending hydraulically-powered plate. The other type is the baling press, where the automobile is compressed from several directions until it resembles a large cube.

In construction, there are three main types of compactor; the plate compactor, the “jumping jack” and the road roller. The roller type compactors are used for compacting crushed rock as the base layer underneath concrete or stone foundations or slabs. The plate compactor has a large vibrating baseplate and is suited for creating a level grade, while the jumping jack compactor has a smaller foot. The jumping jack type is mainly used to compact the backfill in narrow trenches for water or gas supply pipes etc. Road rollers may also have vibrating rollers.

Many retail and service businesses, such as fast food, restaurants, and hotels, use compactors to reduce the volume of non-recyclable waste as well as curb nuisances such as rodents and smell. In the hospitality industry tolerance for such nuisances is particularly low. These compactors typically come in electric and hydraulic operation, with quite a few loading configurations. Most popular loading configurations fall under the following: (1) Ground-Access; (2) Walk-On; and (3) Secured Indoor Chute.

These compactors are almost exclusively of welded steel construction for two reasons: durability under pressure and exposure to the elements, as compactors are installed either completely outdoors or sometimes under a covered loading dock.

There are also trash compactors designed for residential use which, likewise, reduces the volume, smell, and rodent problems of garbage. This can be especially valuable for households which regularly dispose of items such as disposable-diaper boxes or the non-edible portions of vegetables from a large garden. Related to this, there are frequently limits to the number of trash bags/receptacles left outside for residential pickup, which further renders such compactors beneficial to such households.

A need, therefore, exists for a refuse compactor capable of compressing fast food restaurant trash so emptying is infrequently required and a greater mass of waste material can be contained in a smaller volume. Embodiments of the present invention provide a unique solution to this problem.

### SUMMARY OF THE INVENTION

In some embodiments, a refuse compactor for a restaurant facility may include one or more of the following features: (a) a unitized frame coupled to a base plate having a first side panel and a second side panel, the side panels have a front portion, a side wall, and a rear wall, (b) a compaction plate assembly including a one-piece platen pivotally coupled to the side walls for rotation about a fixed axis, (c) a compaction plate driver coupled to the rear wall for driving the platen in a semicircular direction toward and away from a rear wall of a cart, (d) a motor for pivoting the platen from a first position inclined to the horizontal to a second vertical position during a semicircular movement of the compaction plate assembly and returning the platen to the inclined position during an upward movement of the compaction plate assembly, (e) a door member hinged to the front portion and adapted to form a front wall, (f) a hinged panel pivotable about a horizontal axis for selectively blocking the refuse-receiving opening, (g) an actuating motor for automatically pivoting the hinged panel to unblock the refuse-receiving opening, (h) a motion sensor mounted on the door for initiating activation of the motor upon approach of a patron of the restaurant facility within a predetermined distance of the refuse compactor, and (i) an interlock for preventing movement of the hinged panel from an opening blocking position during movement of the compaction plate assembly.

In some embodiments, a compactor may include one or more of the following features: (a) a frame coupled to a base having side panels with a front portion, a side wall, and a rear wall, (b) a compaction plate assembly including a platen pivotally coupled to the side walls for rotation about a fixed axis, (c) a compaction plate driver coupled to the rear wall for driving the platen in a semicircular direction toward and away from a rear wall of a cart, (d) an electrical switch for preventing operation of the compaction plate driver when a door member coupled to the frame is ajar, (e) a speaker for playing an audio message upon actuation of an electric motor, and (f) a motor for pivoting the platen from a first position inclined to the horizontal to a second vertical position during a semicircular movement of the compaction plate assembly and returning the platen to the inclined position during an upward movement of the compaction plate assembly.

In some embodiments, a method of compacting refuse may include one or more of the following steps: (a) opening a waste entry door upon detection of a patron, (b) closing the waste entry door after the patron has deposited refuse into a refuse compactor, (c) compacting the refuse based upon the amount of refuse deposited into the refuse compactor, (d) determining an amount of waste entry door openings, (e) playing an audio message upon detection of the patron approaching the refuse compactor, (f) preventing compaction of the refuse if a refuse compactor door is detected as being open.

### DESCRIPTION OF THE DRAWINGS

FIG. 1 is an isometric view of the trash compactor comprising an embodiment of the present invention;

FIG. 2 is an isometric view from the front and right side of the trash compactor of FIG. 1 showing the internal construction;

FIG. 3 is an isometric view of FIG. 2, but taken from the rear and right side;

FIG. 4 is an isometric view of the frame structure for the embodiment of FIG. 1;

FIG. 5 is an exploded view of the embodiment of FIG. 1;

FIG. 6 is a isometric view of the compactor plate assembly used in the embodiment of FIG. 1;

FIG. 7 is a detailed view of the door motion arm attached to the waste entry door in embodiments of the present invention; and

FIG. 8 is a process diagram showing a method of compacting restaurant waste in an embodiment of the present invention.

### DESCRIPTION OF THE PREFERRED EMBODIMENT

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are directed towards trash compactors for use in fast food restaurants, it is fully contemplated embodiments of the present invention could be utilized anywhere, such as schools, workplaces, government buildings, etc, in any fashion without departing from the spirit of the invention.

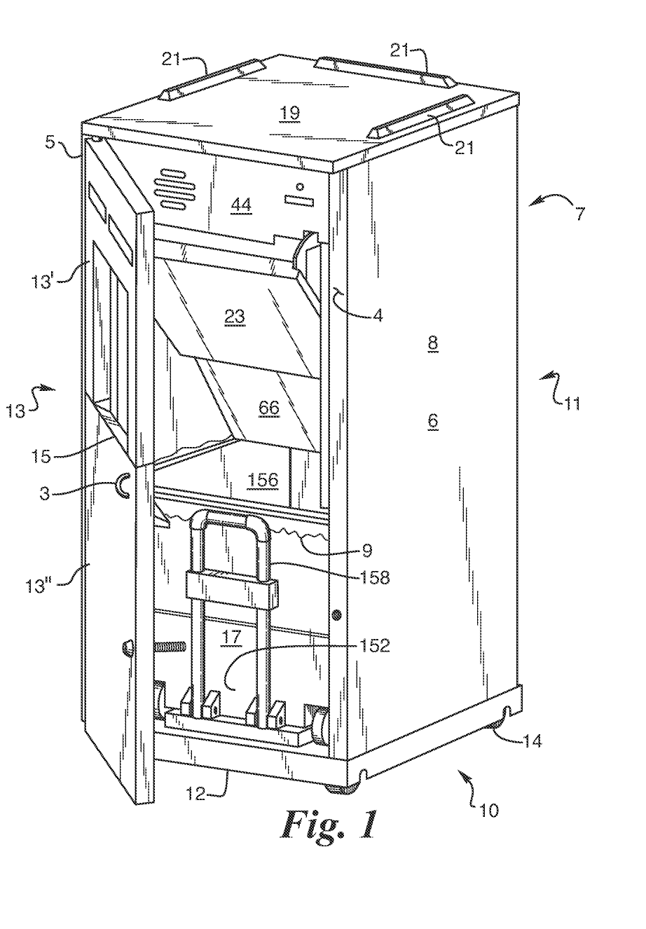

Shown in FIG. 1 is an isometric view of a trash compactor designed for use in fast food restaurants. It is indicated generally by number 10. In this figure, frame 11 forms an enclosure having a pair of sidewalls 8 and a rear wall 7. A door 13 forms a front of compactor 10 having an upper portion 13′ and lower portion 13″ with handle 3. It has an opening 15 through which restaurant waste or the like can be deposited. The waste is adapted to fall into a polyethylene refuse bag 9 used to line box 156 of a removable cart assembly 17 when door 13″ is closed and locked. A removable plastic top panel 19 has upwardly projecting ribs 21 adjacent the side and rear perimeters of top panel 19. The space between ribs 21 provides a convenient place for serving trays to be stacked once the waste has been deposited into cart 17 through opening 15.

Frame 11 can be made of two pieces 5 and 6 of sheet metal which are shaped to provide a front portion 4, a side wall 8, and half the rear wall 7 of frame 11. The construction of frame 11 is discussed in more detail in a co-pending patent application titled “Trash Compactor Cabinet”, Ser. No. ______, filed on ______, the contents of which are herein incorporated by reference in its entirety. Front 4 of frame 11 has a small front facing surface for attaching door 13 for access to compactor 10. Rear 7 has a V-shaped indentation for allowing a passage between rear 7 and shelving in compactor 10 and to give rear 7 added strength. Rear 7 also has a V-shaped overlap portion which connects two pieces 5 and 6 of frame 11 and adds strength to compactor 10. Shelves can be attached to the walls in frame 11 which provide strength for frame 11 and support the mechanisms for compacting trash.

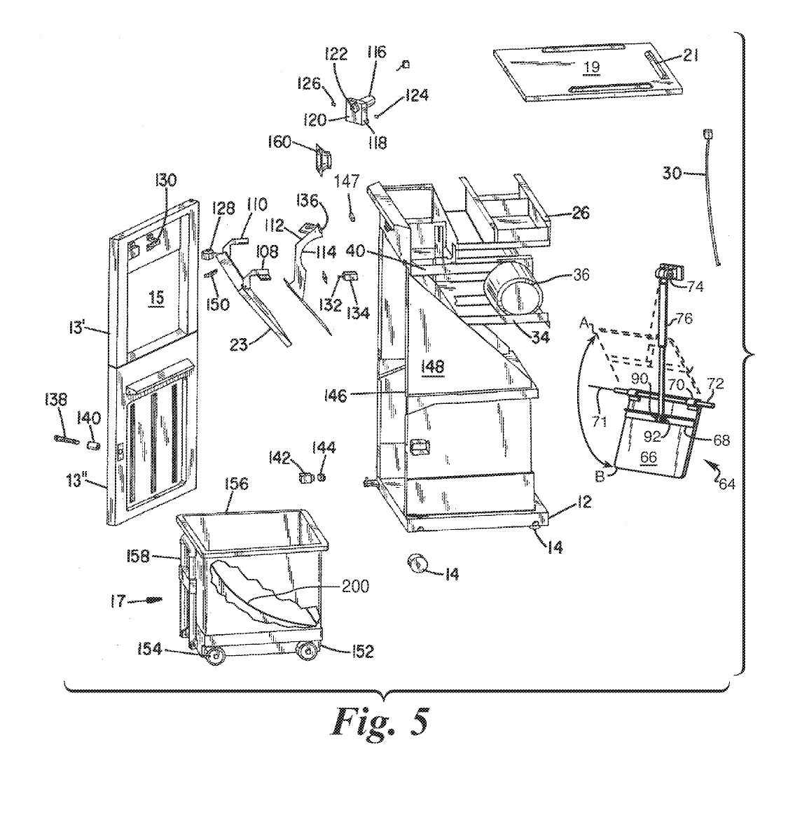

During use, door 13 will be closed and locked. Door 13″ can be opened to remove cart 17 once it is filled with compacted waste material. A motor-operated hinged panel 23 normally blocks opening 15, but swings to an open position when a proximity sensor (FIG. 5) detects the approach of a patron and an audio message is played. The manner in which this is accomplished will be explained in considerably more detail as the description of embodiments continues.

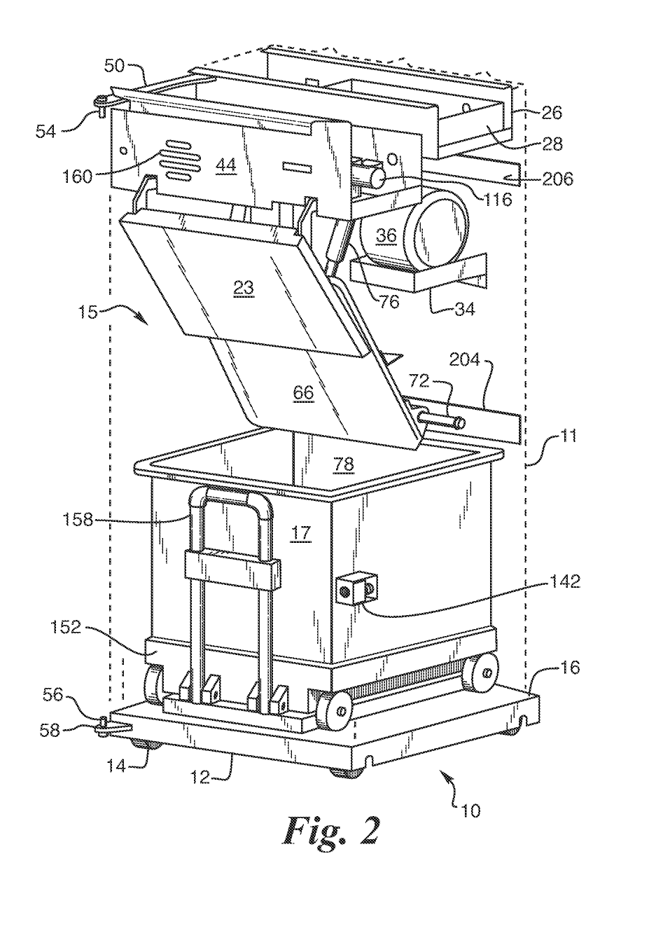

Referring then to FIG. 2, there is shown a front isometric view of a waste compactor constructed in accordance with embodiments of the present invention. It is indicated generally by numeral 10, while frame 11 is shown in a hidden manner to display interior components of compactor 10. Frame 11 can be coupled to a flat, generally rectangular steel base 12 mounted on four caster wheels, as at 14, to facilitate moving and positioning of compactor 10. Welded to upper surface 16 of base 12 at the rear of its opposed sides can be frame 11.

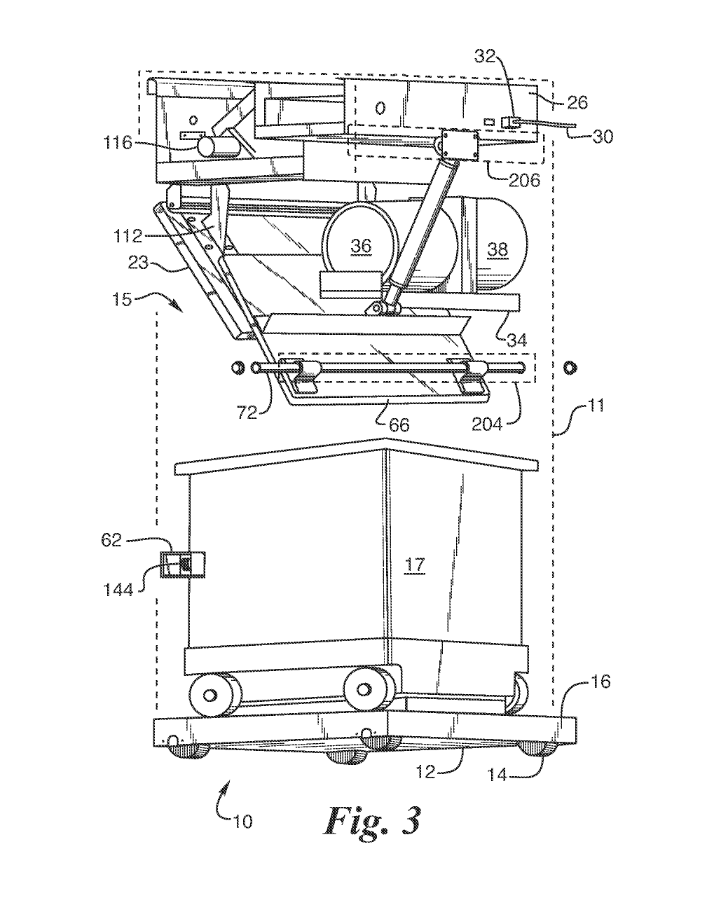

As can be seen in FIG. 3, there is welded to rear 7 and side walls 8 proximate the upper end thereof a steel tray on which is supported an electronic control board assembly 28. Electrical power is delivered to compactor 10 by way of a power cord 30 adapted to plug into a connector 32 on the rear of tray 26.

Disposed below tray 26 and also welded to rear 7 and side walls 8 is a support plate 34 on which is mounted an electric motor 36 coupled in driving relation to a hydraulic pump 38.

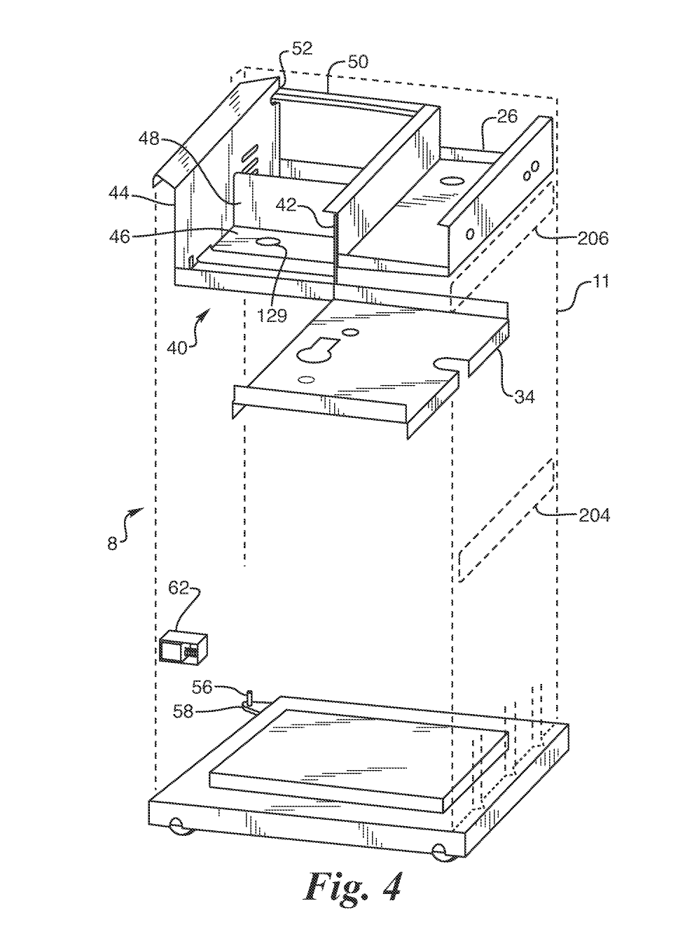

Referring to the isometric view of the frame assembly shown in FIG. 4, also welded to side walls 8 at a location proximate the upper ends thereof is a steel tray 40. It has a vertical rear wall 42 affixed to tray 26. The rear and front walls are connected by a horizontal, forwardly projecting floor plate 46. To add additional rigidity to steel tray 40, a steel plate 48 located approximately midway across the width dimension of steel tray 40 is welded to rear plate 42, front plate 44, and floor plate 46.

Welded to rear plate 42 and to side wall 8 at its upper end a steel arm 50 passes through a notch 52 formed in front wall 44. Secured to arm 50 is a door hinge pin 54, as shown in FIG. 2. A further door hinge pin 56 is affixed to the front edge of base 12 by a forwardly projecting ear 58. Hinge pins 54 and 56 are vertically aligned with one another, allowing door 13 to be suspended thereon. Door 13 as well as coverings 11 are preferably fabricated from fiberglass.

Frame structure 8 shown in FIG. 4 also includes a box-like housing 62 in which a door lock assembly is to be contained.

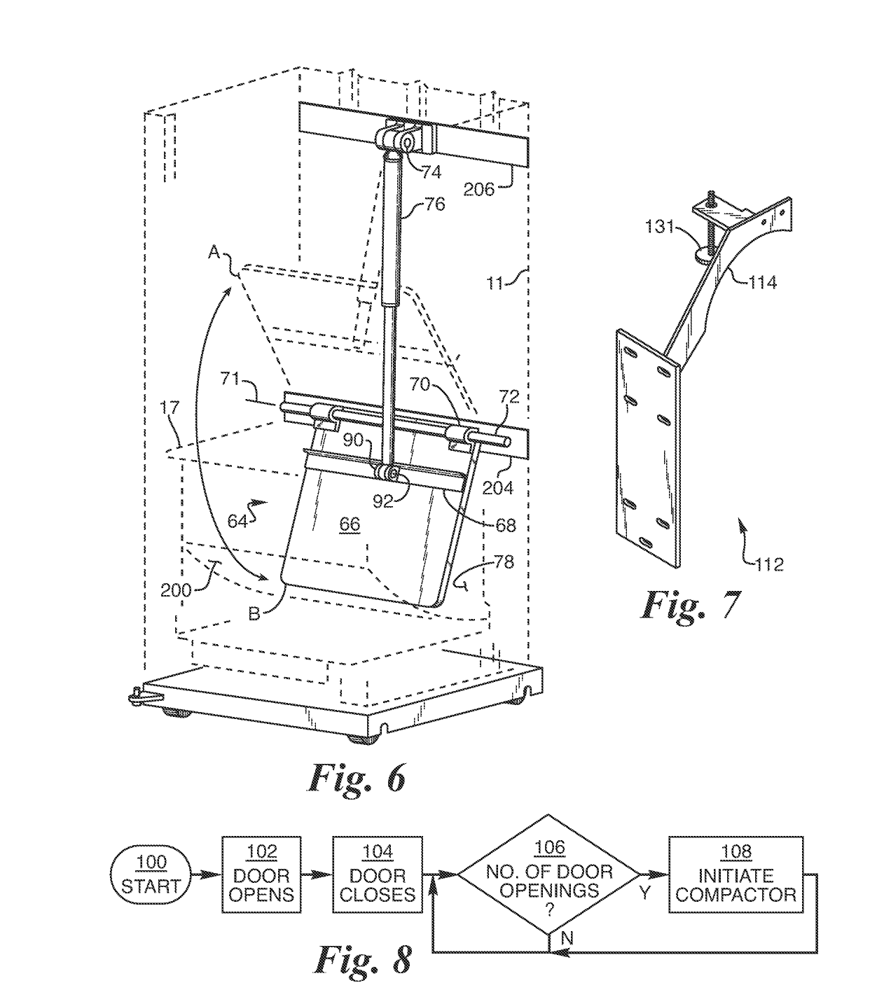

Referring momentarily to the exploded view of FIG. 5 and the view of FIG. 6, there is indicated generally by numeral 64 a compaction plate assembly. It includes a cast aluminum plate or platen 66 pivotally mounted to channel support members side panels. The pivot connection includes a pair of compactor plate bearings 70, disposed along the side-rear edges of compaction plate 66, through which a cylindrical pin 72 extends to allow rotation of the platen 66 about an axis 71. A metal brace 204 provides support along the rear 7 to prevent buckling of rear 7 and side walls 8 during the compaction cycle.

With continued reference to compaction plate assembly 64 of FIG. 5, affixed to channel support member 68 is a hydraulic ram 76. Ram 76 attaches to rear 7 with pin assembly 74 and is oriented where pressurized hydraulic fluid from pump 38 causes compaction plate 66 to execute a compaction stroke whereby trash deposited in the cart 17 is crushed and compressed against backside 78 of cart 17. Pin assembly 74 is bolted to metal plate 206 extending across rear 7 to provide support for rear 7 during the compaction cycle. Compaction plate assembly 64 is less expensive than prior compaction devices. Fewer materials are required for the construction of compaction plate assembly 64. Guide rails typically required for compaction devices are eliminated due to ram 76 being connected to platen 66 at one end and rear 7 at the other end. Thus ram 76 moves through its range of motion without guide rails. Further, only one hydraulic cylinder is necessary, substantially reducing the cost from prior compactors requiring two or more hydraulic cylinders. In addition, platen 66 is not fully supported by ram 76. Instead, platen 66 is supported by ram 76 and side walls 8 and rear 7 thus reducing the amount of lifting ram 76 must perform.

Platen 66 performs a semicircular path from uncompressed state A to compressed state B when ram 76 is hydraulically energized causing ram 76 to press downward. Ram 76 is pivotally mounted to platen 66 at bracket 90 and held in place with pin 92. Bracket 90 is located off center and close to support member 68. This causes platen 66 to travel in a semicircular path as ram 66 extends outward rotating about axis 71 and thus all waste material is pushed and compacted toward rear 78 of cart 17. Further, cart 17 can have an incline 200 from front to rear to assure no trash accumulates on platen 66 when it is brought back into the upward position “A”.

To avoid having trash deposited on the top surface of the compaction plate 66, compaction plate 66 can be inclined as shown in FIGS. 2 and 3 as waste is being deposited through door opening 15. However, in order to effect compaction, plate 66 must assume a declined disposition during its semicircular compaction stroke and return to its inclined disposition at the end of the compaction stroke.

Returning again to the exploded view of FIG. 5, waste entry door 23 is pivotally mounted to a pair of door hinge arms 108 and 110 which fasten by screws to floor plate 46 (FIG. 4) of the steel tray 40. Fastened to the inside surface of hinge panel 23 is a door motion arm 112 having an arcuate cam profile 114 formed therein along its length dimension. Also mounted on floor plate 46 of the tray 40 is a door actuating motor 116 which is coupled through a gear box 118 to one end of an arm 120 supporting a cam follower roller 122 on the free end thereof. Arm 120 is joined to an output shaft of gear box 118, as is a further cam (not shown). This further cam cooperates with Microswitches™ 124 and 1 26 which are connected in circuit with motor 116 to cause arm 120 to be rotated 180° upon each actuation of motor 116.

Roller 122 is positioned to cooperate with arcuate surface 114 on arm 112 so as arm 112 moves through 180°, waste entry door 23 swings open to the position shown in FIGS. 2 and 3, allowing waste to be dumped into cart 17. Because the platform of the compaction plate assembly is inclined, it does not interfere with the opening of hinged panel waste entry door 23.

The actuation of motor 116 is controlled by a commercially available motion sensor 128 mounted to a bracket 130 on an upper rear surface of main entry door 13. Thus, when door 13 is closed and locked, as a patron approaches the waste compactor 10, the motion is detected and a signal is sent to motor 116 to initiate a 180° swing of arm 120 to first open waste entry door 23. As the patron moves away after depositing refuse into compactor 10, the action is again sensed and motor 116 is triggered to rotate arm 120 an additional 180°, allowing waste entry door 23 to reclose. To prevent door 23 from bouncing upon closure thereof, a permanent magnet 129 is mounted on tray 46 (FIG. 4) attracting a ferrous metal disk 131 suspended by a threaded rod from an appendage on arm 112 as shown in FIG. 7.

A programmable logic array comprising electronic circuit 28 is configured to initiate a compaction cycle after a predetermined number of openings of waste entry door 23. For example, and without limitation, electronic circuit 28 may be programmed for patrons approaching and depositing refuse into cart 17 and initiate a compaction cycle whereby refuse is compressed against the rear wall of cart 17.

To prevent waste entry door 23 from opening during the compaction cycle an interlock is provided to block waste entry door 23 from opening during a compaction cycle. Specifically, a solenoid 132 is mounted on a rear surface of rear end plate 42 of steel tray 40 with solenoid plunger 134 extending through a hole drilled in the plate. When the solenoid is energized, plunger 134 extends in a forward direction to overlay and interfere with a stop bracket 136 affixed to swing arm 112 to which the waste entry door 23 attaches. The pin on the solenoid thus blocks waste entry door 23 from being swung open so long as solenoid 132 is energized. At the completion of the compaction stroke and return of the compaction plate to its elevated and tilted disposition, the solenoid is deenergized, retracting pin 134, thus allowing swinging movement of waste entry door 23 under control of motor assembly 116.

The door lock for securing door 13 can have a socket head bolt 138 designed to pass through a sleeve 140 mounted in door 13. Bolt 138 is sufficiently long to project through the thickness dimension of door 13 and into a threaded block 142. Block 142 is urged forward within the confines of the box-like housing 62 by a helical spring 144. Using an Allen wrench, bolt 138 may be rotated to draw door 13 against vertical edge 146 of inner wall 148 disposed in the frame and preventing door 13 from being opened by persons not having an appropriate Allen wrench.

To prevent actuation of the compaction plate assembly if door 13 is open, a magnetic proximity switch of a well-known type has its switch contact member 147 fastened to front wall 44 of steel tray 40 at a position where it will be actuated when a magnet 150 is affixed to the inside surface of main door panel 13 when brought into close proximity to it. Thus, only when door 13 is closed will the switch contacts of magnetic switch 148 be closed to permit motor 36 to drive the hydraulic pump to run.

Cart 17 includes a base tray 152 mounted on wheels 154 and supported on the base tray as a separable trash-receiving chamber 156. Chamber 156 has four sidewalls and an open top. For convenience, a polyethylene bag 9 may be inserted into chamber 1 56 for ultimately containing the trash once compacted. A pull handle 158 is pivotally attached to base 152 to facilitate removing a filled and compacted mass of waste material through open door 13 and to a temporary storage site. Once at the storage site, tube-defining chamber 156 can be lifted free of tray 152, leaving a compacted trash-filled bag for ultimate disposal by a trash hauling company.

With reference to FIG. 8, a process diagram showing a method of compacting restaurant waste in an embodiment of the present invention is shown. In operation, door 23 opens when motion sensor 128 detects a patron moving close to compactor 10 at state 102. After the patron has deposited their waste into cart 17, door 23 closes at state 104. Compactor 10 then determines how many times door 23 has opened to determine if compactor 10 needs to initiate compaction at state 106. If door 23 has opened a predetermined amount of times (e.g., between 5-10), then compactor 10 proceeds to state 108 to initiate compaction. If door 23 has not opened the predetermined amount of times, then compactor 10 returns to state 106. When compaction has been completed, compactor 10 returns to state 106 to begin counting door openings once again.

It has also been found desirable to mount an audible speaker 160 to front wall 44 of steel tray 40 where the speaker is coupled by wires to a voice chip integrated circuit on electronics panel 28. As in many telephone answering machines, these voice chips may be used to store several short audio messages played each time a patron causes waste entry door 23 to swing open as a marketing tool. The messages may thank the patron for visiting the restaurant or for dumping his/her trash, etc.

Thus, embodiments of the COMPACTOR WITH PIVOTING COMPACTION PLATE are disclosed. One skilled in the art will appreciate the present teachings can be practiced with embodiments other than those disclosed. The disclosed embodiments are presented for purposes of illustration and not limitation, and the present teachings are limited only by the following claims.

1. A refuse compactor for a restaurant facility comprising:
a unitized frame coupled to a base plate having a first side panel and a second side panel, the side panels have a front portion, a side wall, and a rear portion;
a door member hinged to the front portion and adapted to form a front wall;
a compaction plate assembly including a one-piece platen pivotally coupled to the side walls for rotation about a fixed axis; and
a compaction plate driver coupled to a rear wall of the frame for driving the platen in a semicircular direction toward and away from a rear wall of a cart.

2. The compactor of claim 1, further comprising a motor for pivoting the platen from a first position inclined horizontally to a second vertical position during a semicircular movement of the compaction plate assembly and returning the platen to the inclined position during an upward movement of the compaction plate assembly.

3. (canceled)

4. The compactor of claim 1, further comprising a hinged panel pivotable about a horizontal axis for selectively blocking a refuse-receiving opening.

5. The compactor of claim 4, further comprising an actuating motor for automatically pivoting the hinged panel to unblock the refuse-receiving opening.

6. The compactor of claim 5, further comprising a motion sensor mounted on the door for initiating activation of the motor upon approach of a patron of the restaurant facility within a predetermined distance of the refuse compactor.

7. The compactor of claim 6, further comprising an interlock for preventing movement of the hinged panel from an opening blocking position during movement of the compaction plate assembly.

8. A compactor comprising:
a frame coupled to a base having side panels with a front portion, a side wall, and a rear portion;
a hinged panel on a door operably coupled to the front portion, the hinged panel adapted to move to an open position upon detection of a compactor user;
a compaction plate assembly including a platen pivotally coupled to the side walls for rotation about a fixed axis; and
a compaction plate driver coupled to a rear wall for driving the platen in a semicircular direction toward and away from a rear wall of a cart.

9. The compactor as in claim 8, further comprising an electrical switch for preventing operation of the compaction plate driver when a door member coupled to the frame is ajar.

10. The compactor as in claim 8, further comprising a speaker for playing an audio message upon actuation of an electric motor.

11. The compactor as in claim 8, wherein the cart is a wheeled cart adapted to sit on the rectangular base, the cart supporting a removable container into which refuse can be deposited and compacted.

12. The compactor as in claim 8, wherein the compaction plate driver includes a hydraulic ram, an electric motor and a hydraulic pump driven by the electric motor with the hydraulic pump being connected to the hydraulic ram and the electrical switch being connected in circuit with the electric motor.

13. The compactor of claim 8, further comprising a motor for pivoting the platen from a first position inclined horizontally to a second vertical position during a semicircular movement of the compaction plate assembly and returning the platen to the inclined position during an upward movement of the compaction plate assembly.

14. A method of compacting refuse, comprising the steps of:
opening a waste entry door upon detection of a patron;
closing the waste entry door after the patron has deposited refuse into a refuse compactor; and
compacting the refuse based upon the amount of refuse deposited into the refuse compactor.

15. The method of claim 14, further comprising the step of determining an amount of waste entry door openings.

16. The method of claim 14, further comprising the step of playing an audio message upon detection of the patron approaching the refuse compactor.

17. The method of claim 14, further comprising the step of preventing compaction of the refuse if a refuse compactor door is detected as being open.

18. The method of claim 14, wherein a motor pivots a platen from a first position inclined to the horizontal to a second vertical position during a semicircular movement of a compaction plate assembly during refuse compaction.

19. The method of claim 18, wherein the motor returns the platen to the inclined position during an upward movement of the compaction plate assembly after refuse compaction.
